(19) United States
(12) Patent Application Publication
(10) Pub. No.: US 2009/0279144 A1
(43) Pub. Date: Nov. 12, 2009

(54) IMAGE PROCESSING APPARATUS, IMAGE DATA CREATION METHOD AND IMAGE DATA CREATION PROGRAM

(75) Inventor: Takeshi Ikusawa, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 12/327,372

(22) Filed: Dec. 3, 2008

(30) Foreign Application Priority Data
May 12, 2008 (JP) 2008-124428

(51) Int. Cl. G06K 15/00

(52) U.S. Cl. 358/3.28

(57) ABSTRACT

An image processing apparatus including an imposition processing section which arranges plural page images on an output area to form an imposed image; and a tint block composition processing section which composes a tint block image on the imposed image, wherein the imposition processing section arranges at least two page images in different directions, and the tint block composition processing section establishes an angle of rotation of the tint block image for each page image so that a relationship between a direction of the each page image and a direction of the tint block image is kept constant, and executes the imposition by utilizing the angle of rotation.

### CROSS REFERENCE TO RELATED APPLICATION

The present application is based on Japanese Patent Application No. 2008-124428 filed with Japanese Patent Office on May 12, 2008, the entire content of which is hereby incorporated by reference.

### BACKGROUND OF THE INVENTION

1. Field of the invention

The present invention relates to an image processing apparatus, an image data producing method and an image data producing program, and in particular, to an image processing apparatus capable of imposition processing and of tint block composition processing of and to an image data creation method as well as an image data creation program in the image processing apparatus.

2. Description of Prior Art

Image forming apparatuses such as a copying machine and a multi function peripheral (MFP) are in widespread use, and in the recent image forming apparatus, it is possible to conduct processing to arrange plural page images on an output area (hereinafter, called imposition processing) and to conduct processing to embed specific characters and patterns in a document in a way to make it impossible to recognize with naked eyes (hereinafter, called tint block composition processing. In the meantime, as a hardware mode to realize the imposition processing and the tint block composition processing, there are available a mode wherein an image processing apparatus practicing the aforesaid processing is provided separately from an image forming apparatus as a printer controller, and a mode wherein an image processing apparatus is incorporated in the image forming apparatus in a unified manner.

With respect to the aforesaid imposition processing, Unexamined Japanese Patent Application Publication No. 2007-235345, for example, discloses a method wherein, when acquiring a direction and a size of image data in plural pages, then, determining arrangement pattern in the case of arranging image data of each page on an output area based on the direction and the size of image data of each page acquired, and arranging image data of pages on an output area based on the determined arrangement pattern, the arrangement pattern is determined by changing the direction of image data on any page, if the acquired image data of each page include the image data of the same direction and different sizes.

In this case, in order to make specific characters and patterns (hereinafter, called tint block images) utilized for tint block composition processing inconspicuous for human eyes directly, and to making the tint blocks to be conspicuous when having been copied, tint block images are adjusted to have density of pixels, a size, a form and an angle of a pixel which are different from those of ordinary images.

Therefore, if there are conducted image processing operations such as enlargement/reduction and rotation for images overlapped for imposition after composing page images and tint block images in a memory of the image processing apparatus, there occurs a trouble that a tint block image is too conspicuous beyond necessity, or it becomes to be inconspicuous even when copies are made, and a primary function of tint blocks is lost. Therefore, when practicing imposition processing and tint block composition processing, processing operations are usually carried out in the order wherein a plurality of page images are imposed, and then, tint block images are composed.

However, in the imposition with an assumption of sheet cutting, imposition is conducted by rotating page images so that a side for cutting comes to a fixed position (for example, upper side of each page image) for each page image. Therefore, if tint block images are composed for images wherein plural page images are imposed in different directions, a direction of each page image does not agree with that of a tint block image. As a result, a direction of a tint block image is varied for each page, resulting in a problem that an external appearance of a printed material after cutting is extremely worsened.

The present invention has been achieved in view of the aforesaid problems, and an object of the invention is to provide an image processing apparatus capable of dissolving deterioration of an external appearance caused in the case of composing tint block images after imposition, an image data creation method and an image data creation program.

### SUMMARY

For attaining at least one of the aforesaid objects, an image processing apparatus reflecting one aspect of the present invention includes: an imposition processing section which arranges plural page images on an output area to form an imposed image; and a, tint block composition processing section which composes a tint block image on the imposed image, wherein the imposition processing section arranges at least two page images in different directions, and the tint block composition processing section establishes an angle of rotation of the tint block image for each page image so that a relationship between a direction of the each page image and a direction of the tint block image is kept constant or consistent, and executes the imposition by utilizing the angle of rotation.

The image processing apparatus reflecting another aspect of the present invention is the apparatus described above, wherein the imposition processing section records, on each pixel of each page image, information of direction that specifies a direction of the each page image in which the each pixel belongs, and the tint block composition processing section establishes the angle of rotation of the tint block image to be composed on the each pixel, based on the information of direction.

Further, image processing apparatus reflecting another aspect of the present invention is the apparatus described above, wherein information of definition, which specifies a direction of each page image for plural types of imposition processing, is preliminarily recorded, and the imposition processing section records the types of the imposition processing, and the tint block composition processing section establishes the angle of rotation of the tint block image to be composed into each page image, based on the information of definition and the types of the imposition processing.

### BRIEF DESCRIPTION OF THE DRAWINGS

These and other objects, advantages and features of the invention will become apparent from the following description thereof taken in conjunction with the accompanying drawings in which:

FIG. 1 is a diagram showing schematically a configuration of a printing system relating to the first embodiment of the present invention;

FIG. 2 is a block diagram showing a specific structure of an image forming apparatus in which an image processing apparatus relating to the first embodiment of the present invention is incorporated;

FIG. 3 is a diagram showing schematically another configuration of a printing system relating to the first embodiment of the present invention;

FIG. 4 is a flow chart diagram showing printing procedures employing an image processing apparatus relating to the first embodiment of the present invention;

FIG. 5 is a diagram showing an example of a structure for information recorded in an image processing apparatus relating to the first embodiment of the present invention;

FIG. 6 is a diagram for illustrating imposition processing, which shows an original page image;

FIGS. 7(a)-(b) are diagrams for illustrating imposition processing, which shows a page image after imposition and cutting;

FIGS. 8(a)-(c) are diagrams for illustrating tint block composition processing in an image processing apparatus relating to the First Embodiment of the invention;

FIG. 9 is a flow chart diagram showing printing procedures in an image processing apparatus relating to the second embodiment of the present invention;

FIG. 10 is a, diagram showing an example of a structure for information recorded in an image processing apparatus relating to the Second Embodiment of the invention;

FIGS. 11(a)-(b) are diagrams showing relationship between a direction of a page image and that of a tint block image in the second embodiment of the present invention;

FIG. 12 is a flow chart diagram showing printing procedures in a conventional image processing apparatus;

FIGS. 13(a)-(b) are diagrams showing schematically a tint block composition processing in a conventional image processing apparatus; and

FIGS. 14(a)-(b) are diagrams showing schematically a tint block composition processing in a conventional image processing apparatus.

### DETAILED DESCRIPTION OF THE PREFERRED EMBODIMENTS

As is shown in the background of the invention, when conducting imposition processing for arranging plural page images on an output area (a single sheet) and tint block composition processing for composing tint block images, there is used a method wherein a tint block image is composed to the image on which each page image has been imposed, because functions of tint blocks are lost if imposition is conducted after tint block images are composed with each page image.

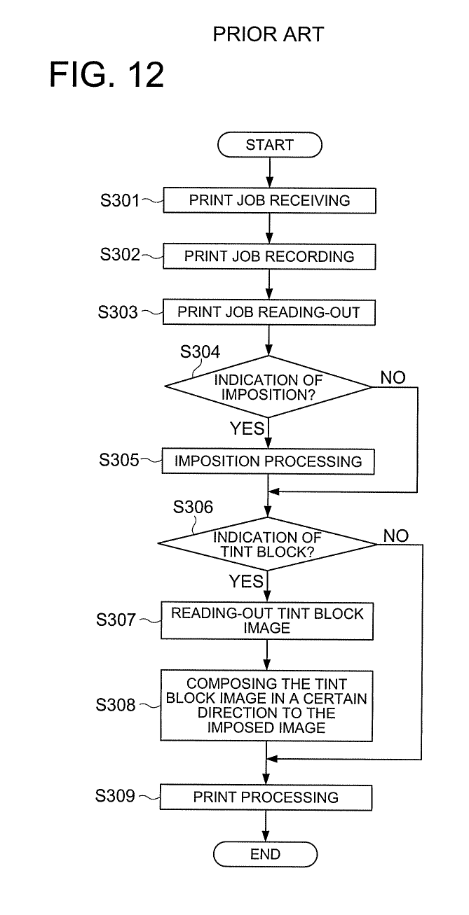

This existing method will be explained as follows, referring to the flow chart diagram in FIG. 12.

First, in step S301, the control section of the image forming apparatus receives a print job from a client, and then, it records the print job thus received on a memory once, in step S302. This print job includes job setting information, page setting information and image information of each page. The job setting information includes setting information concerning imposition processing, setting information concerning tint block composition processing and the number of pages. Further, page setting information includes a size of a sheet used for printing, the number of pixels in a lateral direction (horizontal direction) of each page, the number of pixels in a longitudinal direction (vertical direction) and a page direction. Further, image information of each page includes color information for each pixel. The image information including color information for each pixel may also be described in a form of PDL (Page Description Language) represented by PostScript (registered trademark of Adobe Corp.) and PCL.

Next, in step S303, the control section reads out print job from the memory, then, in step S304, the control section judges whether the imposition is designated referring to setting information of the print job or not, and when the imposition is designated, each page image is imposed based on setting information in step S305, and images after imposition are recorded in the memory. In that case, information of a direction of each page image is lost by this imposition processing.

Next, in step S306, with referring to setting information of the print job, the control section judges whether the tint block composition is designated or not, and when it is designated, the control section reads out tint block images from the memory in step S307, and in step S308, it conducts processing to compose tint blocks in the fixed direction for the image after imposition (namely, for the entire sheet).

After that, in step S309, the control section practices printing processing in accordance with setting information of print job. Specifically, the control section instructs a sheet supply section to take out a sheet, then, instructs an image forming section to write images on which tint blocks are composed and further instructs an image output section to practice finishing processing (such as cutting and book binding) for sheets after image forming.

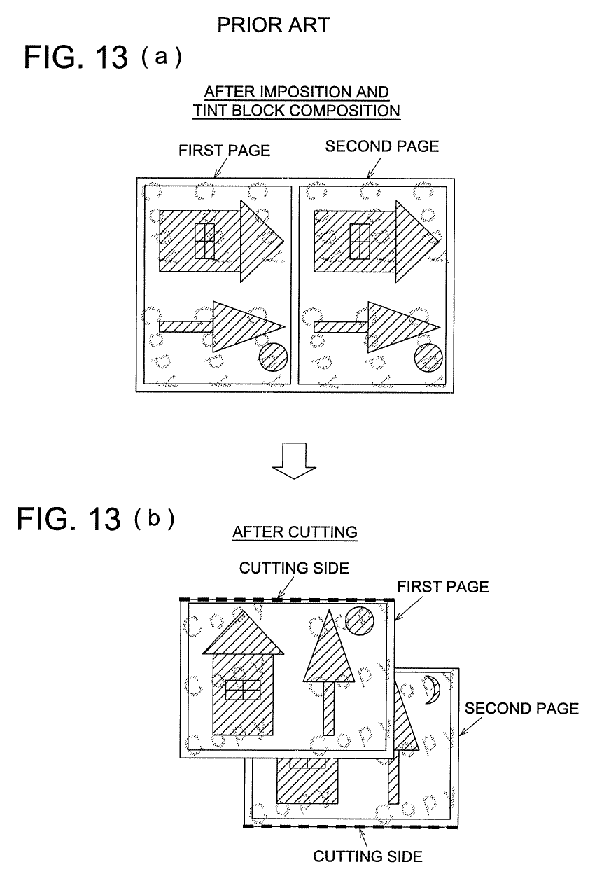

When respective page images are imposed in the same direction as shown in FIG. 13(a), relationship between the direction of each page image and the direction of the tint block image can be made to be fixed or consistent even when tint block composition is carried out after imposition. In this case, however, a position for sheet cutting for each page is varied or inconsistent as shown in FIG. 13(b), resulting in a problem that an external appearance of a printed material in which the respective pages are overlaid with each other is extremely worsened.

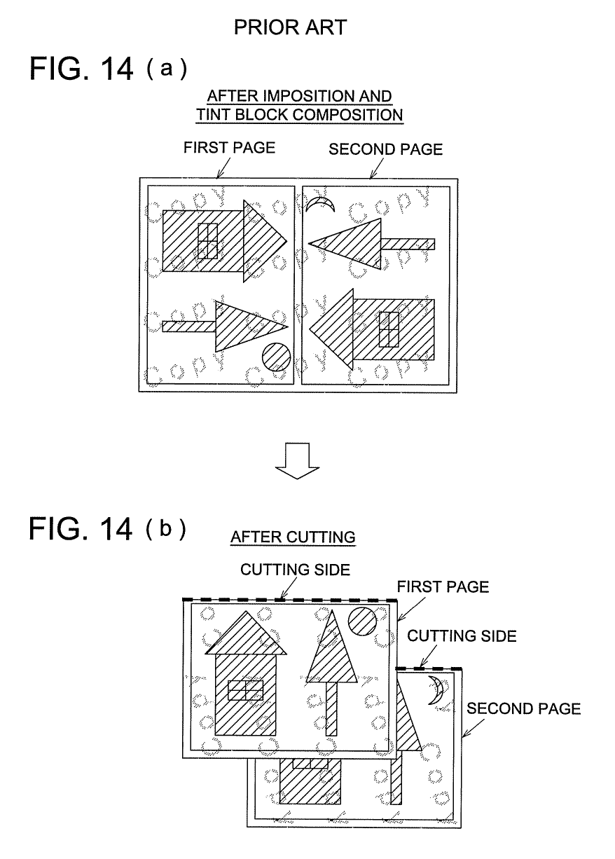

Therefore, imposition is conducted usually by rotating each page image so that a direction of a cut end after cutting may agree with a direction of each page image. In that case, a relationship between a direction of each page image and a direction of a tint block image does not stay constant as shown in FIG. 14(a). Accordingly, a direction of a tint block image is varied for each page, as shown in FIG. 14(b), resulting again in a problem that an external appearance of a printed material in which the respective pages are overlaid each other or stacked is extremely worsened.

In the present embodiment, therefore, when imposing so that cutting sides for respective page images may be in the same position, there are conducted controls to memorize a direction of each page image, and to compose after rotating a tint block image by aligning with the direction of each page image when composing tint block images in images after imposition. Owing to this, even in the case of imposing page images in a different direction under the assumption of sheet cutting, it is possible to make a relationship between a direction of each page image and a direction of a tint block image to stay constant or consistent. The specific method of the foregoing will be explained in detail as follows, referring to the drawings.

### First Embodiment

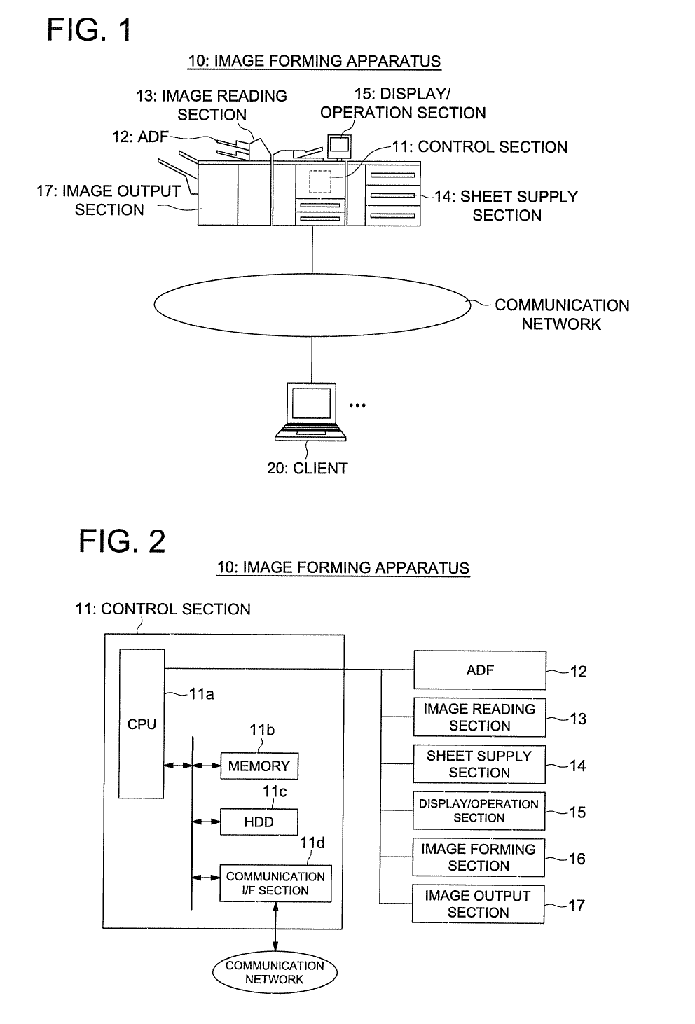

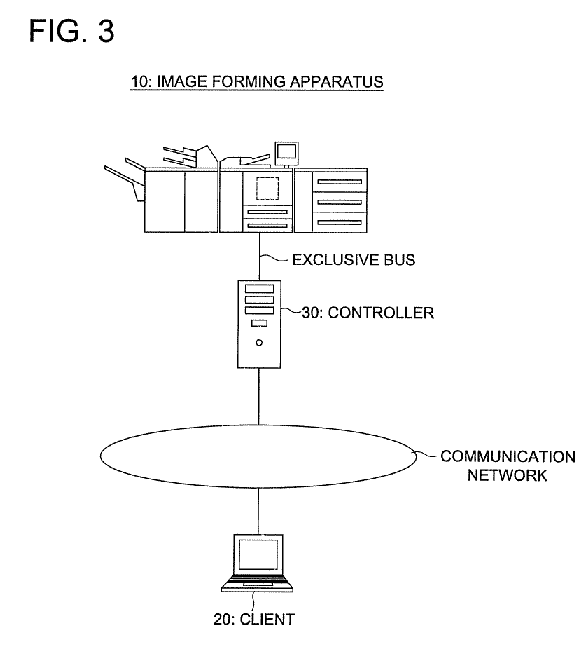

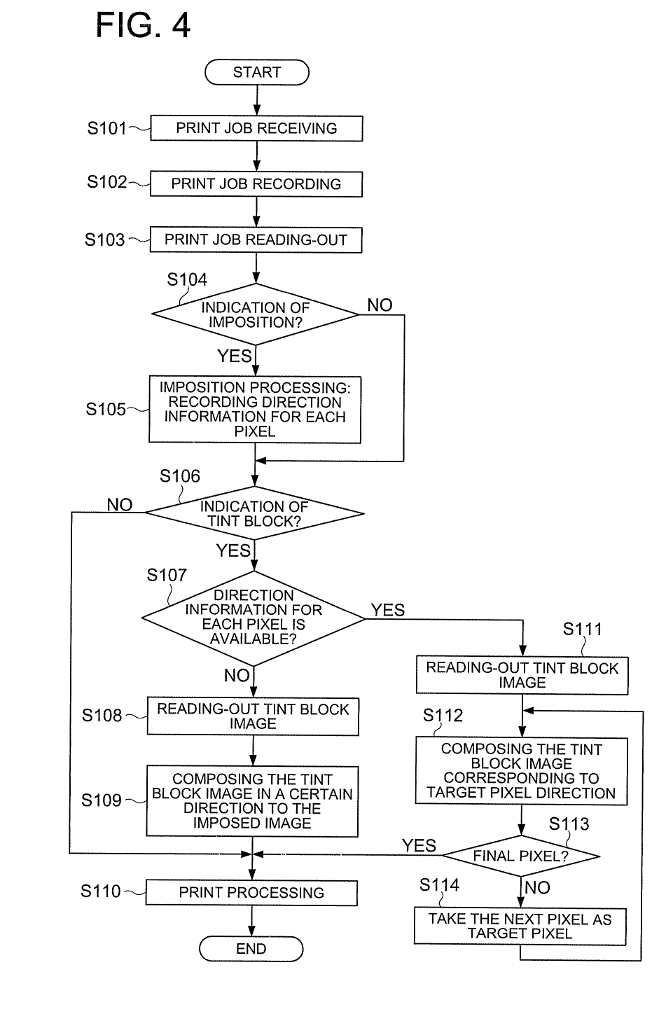

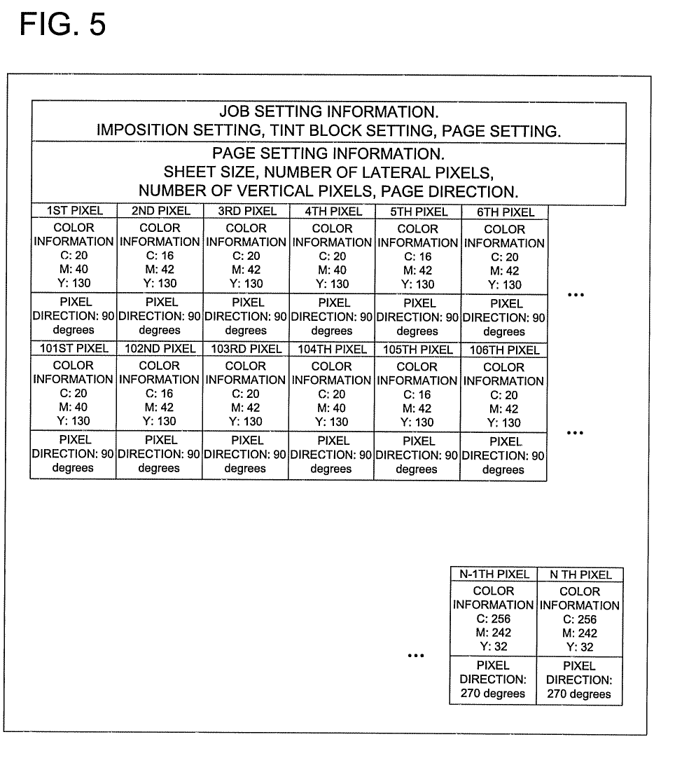

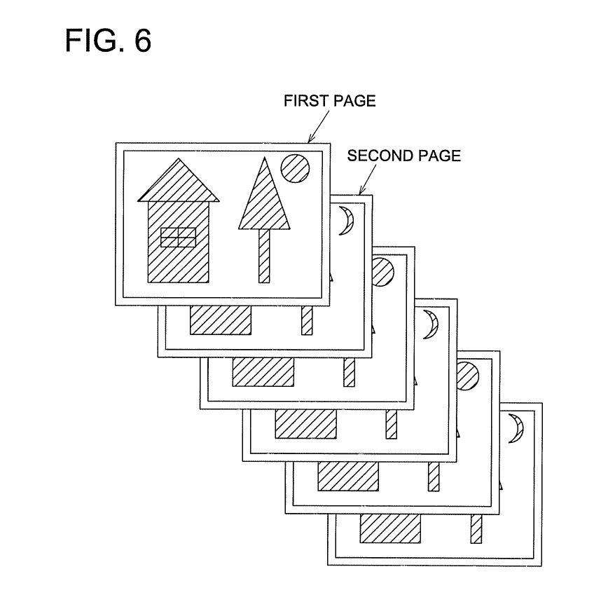

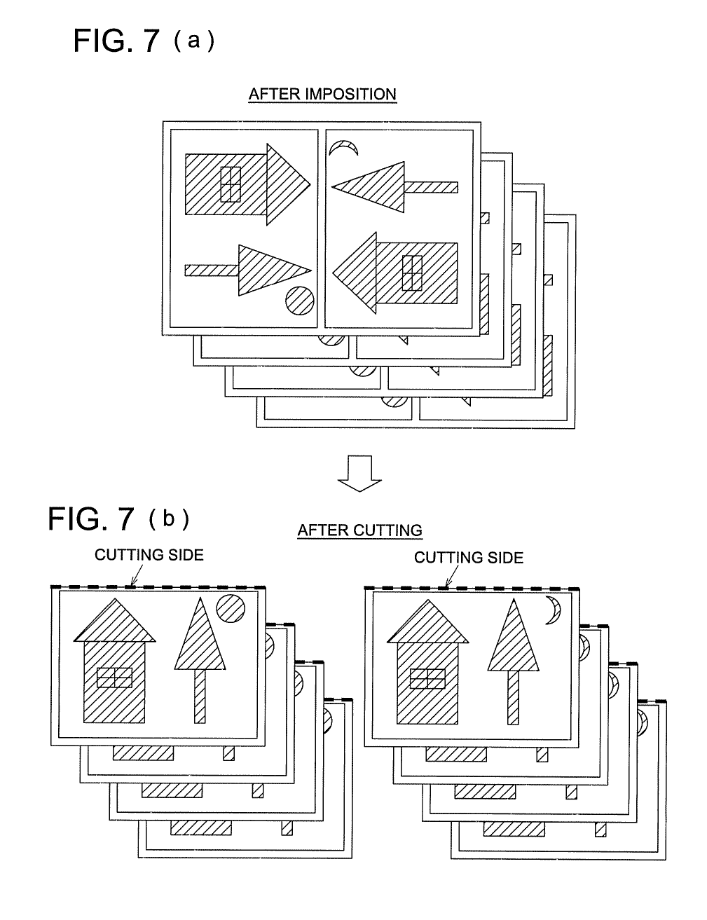

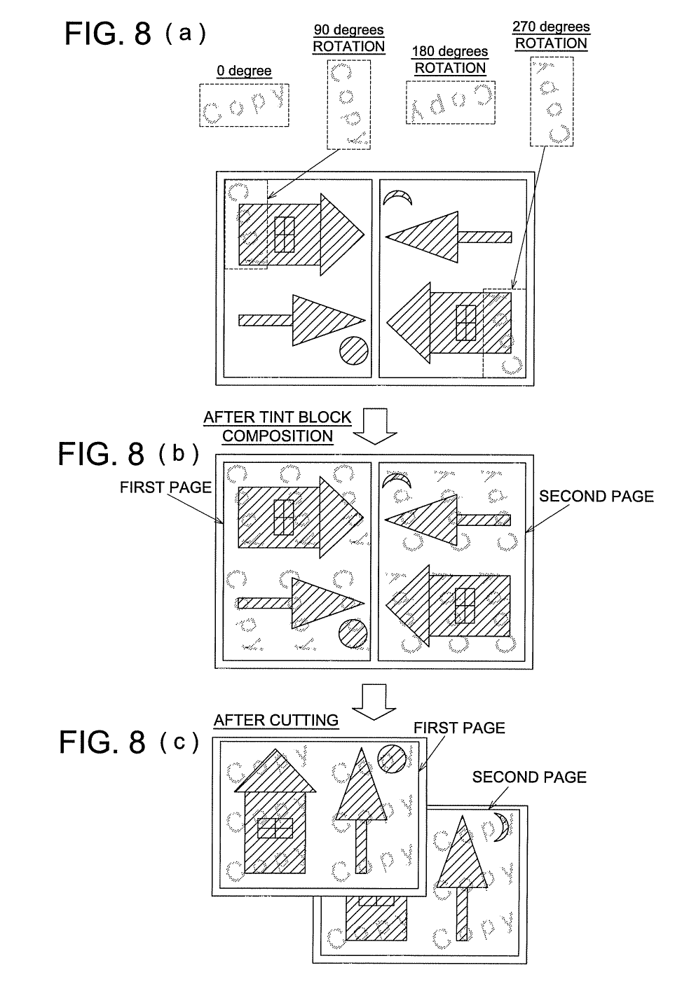

First, an image processing apparatus relating to the first embodiment of the invention, an image data creation method and an image data creation program will be explained, referring to FIGS. 1-8(c). FIG. 1 is a diagram showing schematically a configuration of a printing system relating to the present embodiment, FIG. 2 is a block diagram showing a detailed structure of an image forming apparatus in which an image processing apparatus relating to the first embodiment of the invention is incorporated and FIG. 3 is a diagram showing another example of configuration of a printing system relating to the present embodiment of the invention. Further, FIG. 4 is a flow chart diagram showing printing procedures employing an image processing apparatus relating to the present embodiment, and FIG. 5 is a diagram showing an example of a structure for information recorded in a memory of an image processing apparatus. Further, each of FIG. 6 and FIG. 7(a)-(b) is a diagram for illustrating imposition processing, and FIGS. 8(a)-(c) are diagrams for illustrating tint block composition processing in the present embodiment.

As shown in FIG. 1, the printing system in the present embodiment is composed of client 20 that gives instructions for printing and of image forming apparatus 10 that practices printing which are connected through communication network such as LAN (Local Area Network) or WAN (Wide Area Network).

Client 20 is computer equipment such as a personal computer, and it is equipped with a control section, a memory section, a display section and an operation section which are not illustrated. The control section is composed of memories such as CPU (Central Processing Unit), ROM (Read Only Memory) and RAM (Random Access Memory) and of communication I/F section, and these are connected through a bus.

The aforesaid control section functions as an application for creating a document and as a printer driver that instructs printing of the document, and document data created by the application is converted by the printer driver into printing data of a language that can be read by image forming apparatus 10 (i.e., PDL (Page description Language) such as PCL (Printer Control Language) and PS (Post Script)), and is transmitted to image forming apparatus 10 through communication I/F section.

Further, as shown in FIGS. 1 and 2, the image forming apparatus 10 includes image reading section 13, sheet supply section 14, display/operation section 15, image forming section 16 and of image output section 17.

The control section 11 corresponds to an embodiment example of the image processing apparatus of the invention, and it is configured with CPU 11a, memories such as ROM and RAM, HDD (Hard Disk Drive) 11c and of communication I/F section 11d, which are connected through a bus.

The CPU 11a conducts controls of respective parts and image processing. Memory 11b is a section to store various kinds of data which are read from the image reading section 13, the communication I/F section 11d and from the HDD 11c, and to store data of tint block images, and data thus stored are processed by CPU 11a, and are transferred to the image forming section 16. The HDD 11c stores programs for the CPU 11a to control respective parts and information concerning processing functions of the image forming apparatus itself, which are read out by CPU 11a as occasion demands, and are subjected to practical processing on the memory 11b. The communication I/F section 11d establishes a connection with client 20 or the like, and practices transmitting and receiving of data.

The control section 11 further functions as an image data creation section that conducts processing (hereinafter called RIP (Raster Image Processor) processing) to rasterize printing data (bitmap expansion) to produce multi-level image data, then, to screen (binarization) this multi-level image data to produce binary image data. This image data creation section further conducts imposition processing to arrange page images on each page to be in the prescribed directions, size and order and conducts tint block image composition processing to compose respective page images and tint block images after setting an angle of rotation for the tint block image so that the relationship between a direction of each page image and a direction of a tint block image may stay constant or consistent. This image data creation section may either be organized as a hardware, or be organized as an image data creation program which makes a computer to function as an image data creation section, and thereby, to cause the image data creation program to operate on control section 11.

ADF 12 conveys singular or plural document sheets automatically to image reading section 13.

The image reading section 13 is composed of a light source that scans a document placed on a document table, a CCD (Charge Coupled Devices) image sensor that converts light reflected on the document into electric signals and an A/D converter that converts electric signals on an analog-digital basis, and it reads optically image data from a document sheet on a document table.

Sheet supply section 14 stores sheets for printing, and feeds out the stored sheet for printing to image forming section 16.

Image forming section 16 is composed of constituent elements which are necessary to form an image in an image forming apparatus of various types such as an electrophotographic type, an electro static recording type, an ink-jet type or a heat transfer type, namely, of a photoconductor, a printing head, a drive device for head, a transfer belt, a fixing unit, various types of conveyance rollers and a conveyance belt, and image data on which imposition processing and tint block composition have been carried out by the control section 11 are formed on a sheet for printing as an image to be fed out to image outputting section 17.

Following instructions from the control section 11, the image outputting section 17 gives finishing processing desired by a user including cutting, folding, punching, stapling or bookbinding, on a sheet conveyed from image forming section 16, to output it.

Display/operation section 15 is one wherein a pressure-sensitive operation section (touch panel) in which transparent electrodes are arranged to be in a lattice shape is provided on a display section such as a liquid crystal display (LCD) or an organic EL (electroluminescence) display device, and it makes various types of settings to be possible. For example, it establishes how to arrange respective pages in case of imposition processing, or it establishes a type and a size of a tint block image in case of tint block composition processing.

In the meantime, each of FIGS. 1 and 2 is an example of image forming apparatus 10 in which an image processing apparatus of the present embodiment is incorporated, and only requirement for them is a configuration, where imposition processing and tint block composition processing, are possible. For example, when practicing printing based on printing data transmitted from client 20, ADF 12 and image reading section 13 may be omitted. Further, when practicing printing based on the images which were read by image reading section 13, client 20 can be omitted.

Though the RIP processing is conducted in the image forming apparatus 10 in the aforesaid explanation, it is also possible to employ a configuration wherein controller 30 is arranged on a communication network as an independent image processing apparatus as shown in FIG. 3, and RIP processing, imposition processing and tint block composition processing are conducted by the controller 30, and image data after processing are transmitted to image forming apparatus 10. In this case, an image data creation section may be provided in the controller 30 as hardware or software.

Next, procedures to print by conducting imposition processing and tint block composition processing by using the image forming apparatus having the aforesaid configuration will be explained as follows, referring to a flow chart diagram in FIG. 4.

First, in step S101, control section 11 of image forming apparatus 10 receives a print job from client 20 through communication I/F section 11d, and records the received print job on memory 11b once in step S102. This print job includes job setting information, page setting information and image information of each page, as shown in FIG. 5. The job setting information includes setting information concerning imposition processing (for example, information about whether imposition processing is to be conducted or not, or information about a size and a direction of arrangement for each page image), setting information concerning tint block composition processing (for example, information about whether tint block composition processing is to be conducted or not, or information about a type, a size, a color and density of a tint block image) and the number of pages. Further, the page setting information includes a size of a sheet used for printing, the lateral (horizontal) number of pixels on each page, the longitudinal (vertical) number of pixels and a page direction. Further, color information for each pixel is included in image information on each page.

Next, in step S103, the control section 11 (image data creation section) reads out print job from memory 11b to conduct RIP processing by analyzing print job, and then in step S104, judges whether imposition processing is indicated or not, by referring to setting information of print job. Then, when imposition processing is indicated, the imposition processing is carried out for each image in step S105. For example, when the plural pages shown in FIG. 6 are arranged to be two pages on a single sheet, each page image is rotated so that a cutting side is located at the same position (upper side of page image in this case) for each page image as shown in FIG. 7, and the page image is enlarged or reduced as occasion demands.

Then, image information after imposition processing (image information in the state shown in FIG. 7(a)) is recorded on memory 11b. In this case, in the present embodiment, the image information is recorded on memory 11b by adding information of a direction (90° for the pixels on the left side of a sheet, and 270° for the pixels on the right side, when the rotation is in a clockwise direction) that stipulates a direction of a page image in which the pixel concerned belongs to each pixel constituting an image after imposition, as shown in FIG. 5.

Next, in step S106, control section 11 judges whether or not the tint block composition processing is indicated referring to information of setting a print job, and when it is not indicated, the control section 11 skips to step S110, while, when it is indicated, the control section 11 judges whether each pixel of image information after imposition has direction information (in other words, orientation information) or not, in step S107.

Then, when each pixel has direction information (in the case of the present embodiment), the control section 11 reads out a tint block image from memory 11b in step S111, and composes a tint block image whose direction agrees with direction information of each pixel in step S112, for the first pixel in image information after imposition or the target pixel.

More specifically, plural tint block images each having a different direction and different form (for example, 4 types of tint block images shown on the upper portion in FIG. 8(a)) are recorded on memory 11b in advance, then, a tint block image that is the one rotated by 90° clockwise is composed for pixels of a page image on the left side in FIG. 8(a) and a tint block image that is the one rotated by 270° clockwise is composed for pixels of a page image on the right side in FIG. 8(a). Incidentally, in place of recording tint block images in plural shapes each having a different direction, it is also possible to store a program that generates a tint block image having an arbitrary angle of rotation based on the standard tint block image and angle of rotation, and to prepare a tint block image having a desired angle of rotation by using the program.

Then, in step S113, the control section 11 judges whether or not the target pixel is the last pixel after imposition, and when it is not the last pixel, the control section 11 causes the next pixel to be a target pixel in step S114 to repeat tint block composition processing for step S112 and thereafter, while, when it becomes the last pixel (when tint block images are composed on entire area of the image after imposition as shown in FIG. 8(b)), the flow moves to step S110.

On the other hand, when each pixel does not have direction information in step S107 (on the conventional cases), the control section 11 conducts processing to read out tint block images from memory 11b in step S108 and to compose tint block images in the fixed direction for image information after imposition in step S109.

After that, the control section 11 practices printing processing, following the setting information for print job in step S110. Specifically, the control section 11 gives an instruction to sheet supply section 14 to take out a sheet, then, instructs image forming section 16 to write image information wherein tint block images are composed and instructs image output section 17 to do finishing processing such as cutting the sheets after image forming, to terminate a series of printing processing.

As stated above, information of a direction is recorded for each pixel constituting each page image when conducting imposition processing, and a tint block image in the direction corresponding to information of a direction of each pixel is specified and composed when conducting tint block composition processing. Therefore, even in the case of imposing a page image in the different direction under the assumption of cutting, it is possible to cause a relationship between a direction of each page image and a direction of a tint block image to stay constant, and to improve remarkably an external appearance of a printed material after cutting.

### Second Embodiment

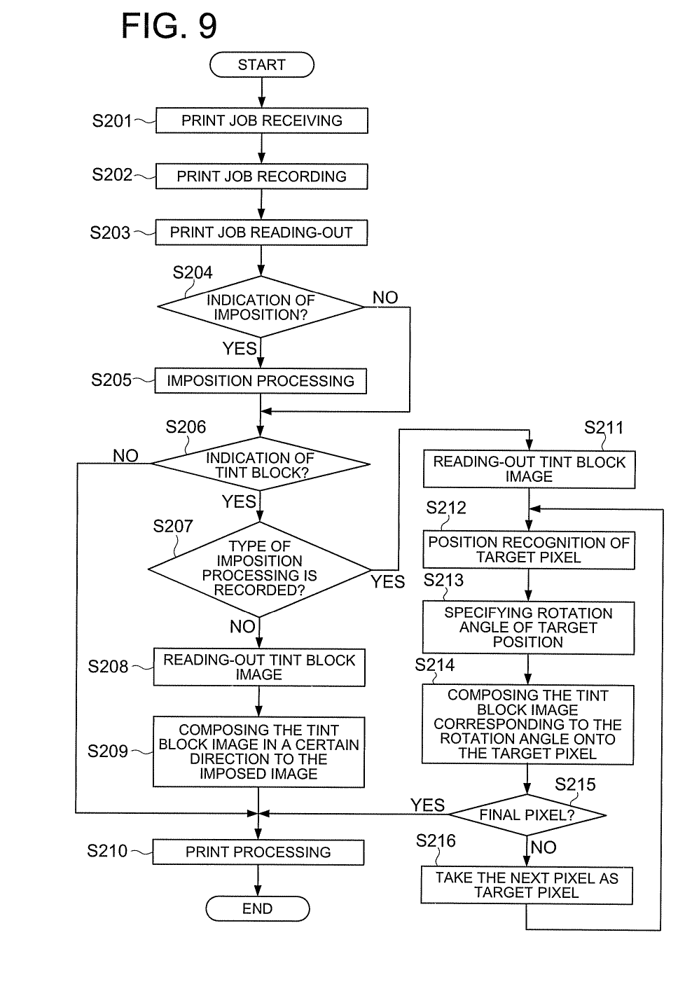

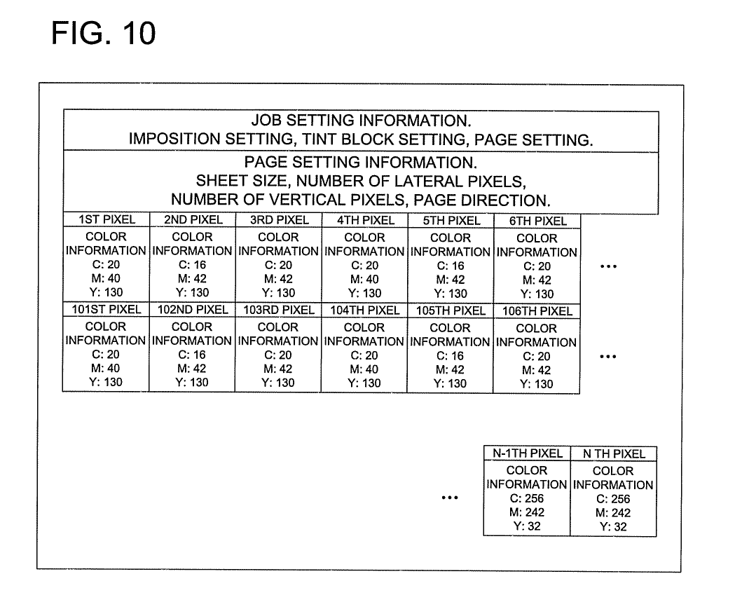

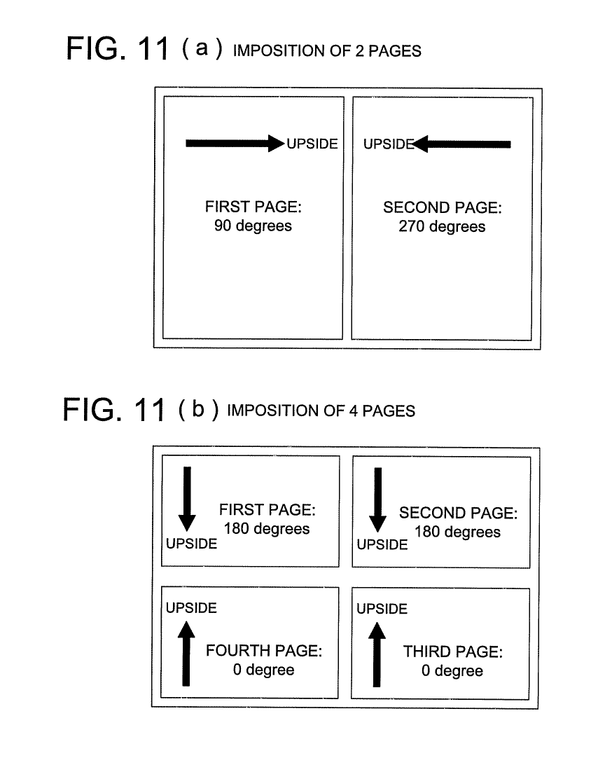

Next, an image processing apparatus relating to the second embodiment of the invention, an image data producing method and an image data producing program, will be explained as follows, referring to FIGS. 9-11(b). FIG. 9 is a flow chart diagram showing printing procedures employing the image processing apparatus relating to the present embodiment, and FIG. 10 is a diagram showing an example of a structure for information to be recorded in a memory in an image processing apparatus. FIGS. 11(a)-(b) are diagrams showing a relationship between a direction of a page image and that of a tint block image.

In the First Embodiment described earlier, there was employed a configuration wherein, when conducting imposition processing, direction information is added to each pixel that constitutes each page image, and an angle of rotation for a tint block image is established based on the direction information for composition. However, it is also possible to employ a configuration wherein, when conducting imposition processing, types of the imposition processing are recorded, and an angle of rotation for a tint block image is established based on the type of the imposition processing for composition. Printing procedures in that case will be explained as follows, referring to the flow chart shown in FIG. 9.

First, in step S201, control section 11 of image forming apparatus 10 receives a print job from client 20 through communication I/F section 11d, and then, records once the received print job on memory 11b in step S202. As shown in FIG. 10, this print job includes job setting information, page setting information and image information of each page. The job setting information includes setting information concerning imposition processing, setting information concerning tint block composition processing and the number of pages. Further, the page setting information includes a size of a sheet to be used for printing, the lateral (horizontal) number of pixels of each page, the longitudinal (vertical) number of pixels and a direction of a page. The image information of each page includes color information of each pixel.

Next, the control section 11 reads out print job from memory 11b in step S203, and judges whether imposition processing is indicated or not, referring to setting information of print job in step S204. When the imposition processing is indicated, the control section 11 conducts imposition processing for each page image in step S205, and records the image information after imposition processing in memory 11b.

In this case, in the present embodiment, an area of each surface (an area where page images are arranged) and angles of rotations (directions of page images) are defined, and this definition information is recorded in memory 11b in advance. For example, in the case of two-page imposition for a landscape document like that shown in FIG. 11(a), a half area on the left side of a sheet representing the first surface is defined as a direction of 90° clockwise for the upper side of the sheet, and a half area on the right side of a sheet representing the second surface is defined as a direction of 270° clockwise. Further, in the case of four-page imposition for a landscape document like that shown in FIG. 11(b), an upper half area on the sheet representing the first and second surfaces is defined as a direction of 180° clockwise, and a lower half area on the sheet representing the third and fourth surfaces is defined as a direction of 0°. Then, the contents thus defined are recorded in memory 11b. Types of imposition in imposition processing (for example, the aforesaid two-surface imposition and four-surface imposition) are further recorded in memory 11b.

Next, the control section 11 judges whether the tint block composition processing is indicated by referring to setting information of print job or not, in step S206, and judges whether a method of imposition is indicated or not in step S207, when the tint block composition processing is indicated.

Then, in the case where imposition processing types are recorded (in the case of the present embodiment), the control section 11 reads a tint block image out of memory 11b in step S211, and recognizes a position of a target pixel for the first pixel in image information after imposition or a target pixel, in step S212. Incidentally, the pixel position can be specified based on order of the pixel and on the longitudinal and lateral numbers of the pixels constituting a page image to which the pixel belongs.

Next, in step S213, the control section 11 specifies an angle of rotation of a tint block image corresponding to a target pixel, based on definition information recorded in memory 11b and types of imposition processing. For example, in the case of the aforesaid two-page imposition, a position of a target image on the left side half represents 90° and a position of a target image on a half on the right side represents 270°, based on definition information. Further, in the case of four-page imposition, an upper half represents 180° and a lower half represents 0°, from definition information. Next, in step S214, the control section 11 composes a tint block image on the target pixel with the specified angle of rotation.

Then, in step S215, the control section 11 judges whether the target pixel is the last pixel in image information after imposition or not, and when it is not the last pixel, the control section 11 makes the next pixel to be the target pixel in step S216, and repeats tint block composition processing on and after step S212, to move to step S210 when the last pixel comes.

On the other hand, in the case where types of imposition processing are not recorded in step 207 (in the conventional case), the control section 11 reads tint block images out of memory 11b in step S208, and conducts processing of composing tint block images in the fixed direction for images after imposition in step S209.

After that, the control section 11 practices printing processing following setting information of print job in step S210. Specifically, the control section 11 instructs sheet supply section 14 to take out a sheet, instructs image forming section 16 to write image information including composed tint block images, and instructs image output section 17 to conduct finishing processing such as cutting the sheet on which image has been formed, and terminates a series of print processing.

In this way, for imposition processing, types of imposition processing are recorded, and for tint block composing processing is conducted, wherein a direction of a tint block image corresponding to each page image is specified based on definition information recorded in advance and on types of imposition processing. Therefore, even in the case of imposing page images in different directions under the assumption of cutting, it is possible to cause relationship between a direction of each page image and a direction of a tint block image to stay constant and to improve remarkably an external appearance of a printed material after sheet cutting.

In the meantime, in the aforesaid each embodiment, an occasion wherein a tint block image is inclined slightly counterclockwise for a page image, to be composed. However, a direction of a tint block image has only to be fixed relative to a direction of each page image, and an angle of a tint block image can be established optionally.

Further, in the aforesaid each embodiment, examples of two-surface imposition and four-surface imposition were explained. However, the invention is not limited to the aforesaid embodiments, and can be applied equally to an occasion wherein page images in the optional number are arranged.

The present invention can be utilized for an image data creation method and for an image data creation program by using an image processing apparatus capable of practicing imposition processing and tint block composition processing, the image processing apparatus being incorporated in the image forming apparatus, or being structured as a separate apparatus.

What is claimed is:

1. An image processing apparatus comprising:
an imposition processing section which arranges plural page images on an output area to form an imposed image; and
a tint block composition processing section which composes a tint block image on the imposed image, wherein
the imposition processing section arranges at least two page images in different directions, and
the tint block composition processing section establishes an angle of rotation of the tint block image for each page image so that a relationship between a direction of the each page image and a direction of the tint block image is kept constant, and executes the imposition by utilizing the angle of rotation.

2. The image processing apparatus of claim 1, wherein the imposition processing section records, on each pixel of each page image, information of direction that specifies a direction of the each page image in which the each pixel belongs, and the tint block composition processing section establishes the angle of rotation of the tint block image to be composed on the each pixel, based on the information of direction.

3. The image processing apparatus of claim 1, wherein information of definition, which specifies a direction of each page image for plural types of imposition processing, is preliminarily recorded, and the imposition processing section records the types of the imposition processing, and
the tint block composition processing section establishes the angle of rotation of the tint block image to be composed into each page image, based on the information of definition and the types of the imposition processing.

4. An image data creation method for creating an image data for printing, comprising:
an imposition step to arrange plural page images on an output area to form an imposed image; and
a tint block composition step to compose a tint block image on the imposed image, wherein
in the imposition step at least two page images are arranged in different directions, and
in the tint block composition step, an angle of rotation of the tint block image for each page image is established so that a relationship between a direction of the each page image and a direction of the tint block image is kept constant, and the imposition is executed by utilizing the angle of rotation.

5. The image data creation method of claim 4, wherein in the imposition step, information of direction that specifies a direction of the each page image, in which the each pixel belongs, is recorded on each pixel of each page image, and
in the tint block composition step, the angle of rotation of the tint block image to be composed on the each pixel, are established based on the information of direction.

6. The image data creation method of claim 4, wherein information of definition, which specifies a direction of each page image for plural types of imposition processing, is preliminarily recorded, and in the imposition step, the types of the imposition processing are recorded, and
in the tint block composition step, the angle of rotation of the tint block image to be composed into each page image, is established based on the information of definition and the types of the imposition processing.

7. A computer-readable storage medium having a program stored thereon for causing a computer to perform an image data creation procedure, the procedure comprising:
an imposition processing step to arrange plural page images on an output area to form an imposed image; and
a tint block composition processing step to compose a tint block image on the imposed image,
wherein the program causes the computer to function as a controller which works such that:
in the imposition processing step, the controller arranges at least two page images in different directions, and
in the tint block composition processing step, the controller establishes an angle of rotation of the tint block image for each page image so that a relationship between a direction of the each page image and a direction of the tint block image is kept constant, and executes the imposition by utilizing the angle of rotation.

8. The computer-readable storage medium of claim 7, wherein in the imposition processing step, the controller records, on each pixel of each page image, information of direction that specifies a direction of the each page image in which the each pixel belongs and
in the tint block composition processing step, the controller establishes the angle of rotation of the tint block image to be composed on the each pixel, based on the information of direction.

9. The computer-readable storage medium of claim 7, wherein the controller preliminarily records information of definition, which specifies a direction of each page image for plural types of imposition processing,
in the imposition processing step, the controller records the types of the imposition processing, and
in the tint block composition processing step, the controller establishes the angle of rotation of the tint block image to be composed into each page image, based on the information of definition and the types of the imposition processing.
